(19) United States
(12) Patent Application Publication
(10) Pub. No.: US 2020/0001860 A1
(43) Pub. Date: Jan. 2, 2020

(54) METHOD FOR CONTROLLING A SHIFTING PROCESS IN A POWERTRAIN OF A VEHICLE

(71) Applicant: AVL LIST GMBH, Graz (AT)

(72) Inventors: Johannes Rumetshofer, Graz (AT); Markus Bachinger, St. Radegund (AT)

(21) Appl. No.: 16/465,447

(22) PCT Filed: Dec. 4, 2017
(86) PCT No.: PCT/AT2017/060319

§ 371 Date: Jun. 11, 2019

(30) Foreign Application Priority Data
Dec. 2, 2016 (AT) A 51096/2016

(51) Int. Cl. B60W 20/11; F16H 61/04; B60W 20/40; B60W 10/02; B60W 10/06; B60W 10/08; B60W 10/12; B60W 30/19

(52) U.S. Cl. CPC B60W 20/11; F16H 61/0403; B60W 20/40; B60W 30/19; B60W 10/06; B60W 10/08; B60W 10/12; B60W 10/02

(57) ABSTRACT

A method is provided for controlling a shifting process in a powertrain of a vehicle, the powertrain having a first and a second drive machine, a transmission connecting the drive machines to a transmission output and at least one coupling which can be shifted, wherein during a shifting process an offgoing coupling is disengaged and/or an oncoming coupling is engaged.

The invention relates to a method for controlling a shifting process in a powertrain of a vehicle which comprises a first and a second drive machine, a transmission connecting the drive machines to a transmission output and at least one shiftable clutch, wherein during a shifting process an outgoing clutch is disengaged and/or an oncoming clutch is engaged, and wherein the transmission comprises at least one transmission mode with a fixed transmission ratio and at least one transmission mode with a variable transmission ratio.

Outgoing clutch means a shiftable clutch of the transmission which is engaged at the beginning of the shifting process and which is disengaged during the shifting process. An oncoming clutch means a shiftable clutch of the transmission which is disengaged at the beginning of the shifting process and is engaged during the shifting process. The term clutch also includes brakes.

There are known powertrain topologies with two drive machines and several transmission modes, wherein these transmission modes can be classified as follows: (1) at least one transmission mode has in each case a fixed gear ratio (FGR) with an additional degree of freedom to allow variable power sharing between two drive machines; (2) at least one CVT transmission mode (CVT=continuous variable transmission) has a variable drive ratio between a drive machine and the transmission output. This true degree of mechanical freedom can be controlled, for example, by the other drive machine or by adjusting the torque of the two drive machines.

Such powertrain topologies allow two degrees of mechanical freedom in a CVT transmission mode. In this way it is possible to control or adjust the slip speed of an oncoming clutch in addition to the wheel drive torque. In an FGR transmission mode (one mechanical degree of freedom) it is possible to control or adjust the torque transmitted to the outgoing clutch in addition to the wheel drive torque.

U.S. Pat. No. 7,356,398 B2 describes the feedback adjustment of an outgoing clutch for an electrically variable transmission to a speed at which no slip occurs. The method described therein is limited to hybrid powertrains with one internal combustion engine and two drive machines, wherein the gear change from a first eCVT mode takes place via a mode with fixed transmission ratio to a second eCVT mode (eCVT=electronic controlled continuous variable transmission).

DE 10 2010 012 259 A1 discloses a method for the feedback adjustment of a hybrid transmission which has three drive elements—an internal combustion engine and two electrical machines. When shifting from an EVT mode (electrically adjustable transmission mode) to an ETC mode (electrical torque converter mode), the oncoming clutch is synchronized before engagement. A relief of the outgoing clutch is not provided. A wheel drive torque is constantly generated during the shifting process, but this does not represent a degree of freedom.

EP 1 502 791 A2 also describes a hybrid transmission with three drive elements. Neither DE 10 2010 012 259 A1 nor EP 1 502 791 A2 provides feedback adjustment of the wheel drive torque during all phases of shifting operations.

From DE 10 2005 006 371 A1 a control system for shifting by a neutral operating mode in an electrically adjustable transmission is known. The slip speed of an oncoming clutch is adjusted towards zero by setting the engine torque. Furthermore, a torque of essentially zero is produced at the output element immediately before a clutch is disengaged. In order to take into account the case that a planned interruption of the output torque is not possible due to limitations, a neutral operating mode is used from a first to a second operating mode, which has a negative effect on the gear change duration and the quality of the shifting (due to interruption of the wheel drive torque).

It is the object of the invention to enable loss-free and smooth shifting processes with two drive elements each for powertrains with a wide variety of topologies, which have at least one transmission mode with variable transmission ratio (CVT transmission mode) and at least one transmission mode with fixed gear ratio (FGR transmission mode), without having to switch a neutral operating mode between two operating modes.

In accordance with the invention, this object is solved that during relief phase the outgoing clutch is relieved before being disengaged (preferably fully) and/or that in a synchronization phase a differential speed between the drive side and the driven side of the oncoming clutch is adjusted to zero before being engaged, wherein at the same time a wheel drive torque continues to be adjusted to a target drive torque which corresponds, for example, to a driver's request.

Irrespective of the transmission shifting state, the available degrees of freedom in the transmission can be fully utilized. The method can be used for a wide variety of transmission topologies with at least one transmission mode with variable transmission ratio and two drive machines. This makes it possible, on the one hand, to optimally implement the specified hybrid strategy and, on the other, to enable loss-free and smooth shifting during a single shifting process.

The second degree of freedom makes it possible to realize operation of the transmission in which the slip speed is zero before disengagement or engagement, while fully maintaining, for example, the target drive torque on the wheels requested by the driver of the motor vehicle within the limits of the two drive machines.

Preferably it is intended that the relief of the outgoing clutch is carried out by adjusting a mating torque of the outgoing clutch to zero. The term “mating torque” here refers to the torque actually applied to the clutch and transmitted via the clutch plates.

Any limitations that occur are not solved via an intermediate neutral operating mode, but via the adjustment/shifting strategy of the hybrid transmission, wherein freedom from dissipation is dispensed with if necessary.

One embodiment of the invention with one mechanical degree of freedom in fixed gear ratio transmission mode (FGR transmission mode) provides that the outgoing clutch is relieved by dividing the drive torque between the first and second drive machines so that the mating torque of the outgoing clutch is zero, while at the same time a wheel drive torque continues to be adjusted to a torque corresponding to a driver's request. This can be done using a suitable strategy to relieve the outgoing clutch for a shifting process.

In one embodiment of the invention with two degrees of mechanical freedom in variable transmission mode (CVT mode), either an optimum operating point for a drive machine is selected via a suitable hybrid strategy or a differential speed of the clutch plates of the clutch to be engaged is adjusted to zero during the shifting process, while at the same time the wheel drive torque is adjusted.

An advantageous embodiment of the invention provides that the torque distribution between the first and second drive motor is carried out by means of a model-based pilot control, preferably by means of a trajectory. The calculation of the torques of the first and second drive machine can thus be carried out on the basis of a mechanical dynamic model, wherein the pilot control values are set by means of these trajectories, e.g. the speed of the vehicle and the slip speed of the oncoming clutch (or the slip torque of the outgoing clutch) and its first, second and third derivations. First, second and third derivation of the vehicle speed and first derivation of the slip speed are necessary here.

It is particularly advantageous if the adjustment of the mating torque of the outgoing clutch and the adjustment of the differential speed between the drive and driven sides of the oncoming clutch are carried out immediately successively during the relief phase or the synchronization phase of the shifting process.

The method according to the invention allows gear change control even with complex powertrain topologies. The prerequisite is that the powertrain topology has two drive machines and several transmission modes, which are classified as follows: (1) at least one fixed gear ratio (FGR) transmission mode having an additional degree of freedom to allow variable power distribution between two drive machines; (2) at least one continuous variable transmission (CVT) mode having a variable drive ratio between a drive machine and the gear output. This true degree of mechanical freedom can be controlled, for example, by the other drive machine or by adjusting the torque of the two drive machines.

A large number of hybrid electric powertrain topologies with several modes, for example, fall under the classification described above. The adjustmentstrategy according to the invention allows even (without torque disturbances) and lossless (without clutch slip) gear changes with the transmission topologies under consideration.

Two different gear change phases are described in detail below:
A) Gear change phase from an FGR transmission mode to a CVT transmission mode (disengaging the outgoing clutch):

The basic control task in FGR transmission mode is to regulate the distribution of the required drive power between the two drive machines. When a gear change command is present, the additional degree of freedom for power distribution is applied to the corresponding torque transmitted across the engaged and outgoing clutches. During the preparation phase, this torque is regulated to zero, so the outgoing clutch is completely relieved. After torque relief, the outgoing clutch can be disengaged slip-free and thus loss-free. Once the outgoing clutch is fully open, the CVT transmission mode is active. In CVT transmission mode, there is a degree of freedom to select the angular speed of a drive machine, for example to increase the energy efficiency. The CVT control regulates the initial angular speed of this drive machine to a required value due to the gear change.
B) Gear change phase from a CVT transmission mode to an FGR transmission mode (engaging the oncoming clutch):

The basic control task in CVT transmission mode is to control the angular speed of one of the drive machines. When a gear change command is present, the degree of freedom is used to adjust the angular speeds of the clutch plates of the oncoming clutch. During the preparation phase, the difference between the angular speeds of the two clutch plates is regulated to zero, i.e. the two clutch plates are thus synchronized. Then the oncoming clutch can be engaged slip-free and thus loss-free. As soon as the oncoming clutch is engaged, the FGR transmission mode is active. In the FGR transmission mode, the torque distribution of the two drive machines is carried out according to the requested drive torque on the basis of the operating strategy stored in the electrical control unit (HCU=Hybrid Control Unit).

A traction interruption during shifting can be avoided if the transmission is operated with a fixed transmission ratio during the outgoing clutch relief phase and/or with a variable transmission ratio during the oncoming clutch synchronization phase. The torque distribution is selected in such a way that, on the one hand, the required drive torque is available unchanged at the drive wheels and, on the other hand, the mating torque of the outgoing clutch is adjusted to zero during the relief phase and/or, during the synchronization phase, an adjustment of the speeds of the clutch plates of the oncoming clutch is achieved.

The transmission can be operated with a fixed gear ratio (FGR transmission mode) corresponding to the respective gear before the outgoing clutch relief phase and/or after the oncoming clutch synchronization phase. Similarly, the transmission can be operated with a variable transmission ratio after the relief phase and/or before the synchronization phase.

In compliance with the above-mentioned regulation objectives, the strategy according to the invention allows complete access to the vehicle dynamics (drive torque), which enables a smooth gear change during the entire gear change process. Since the clutch plates of the clutch are engaged or disengaged in the unloaded state (with respect to the transmitted torque) or synchronized state (with respect to the difference in the angular velocities of the clutch plates), clutch actuation is generally uncritical.

In principle, the method according to the invention is not limited to a specific control or regulation procedure. The use of a pilot control based on model inversion is only one of several possibilities. It allows the calculation of necessary torques to achieve the defined control objectives. An additional regulation loop can eliminate model inaccuracies.

The invention is explained in more detail below by reference to the non-restrictive figures, wherein:

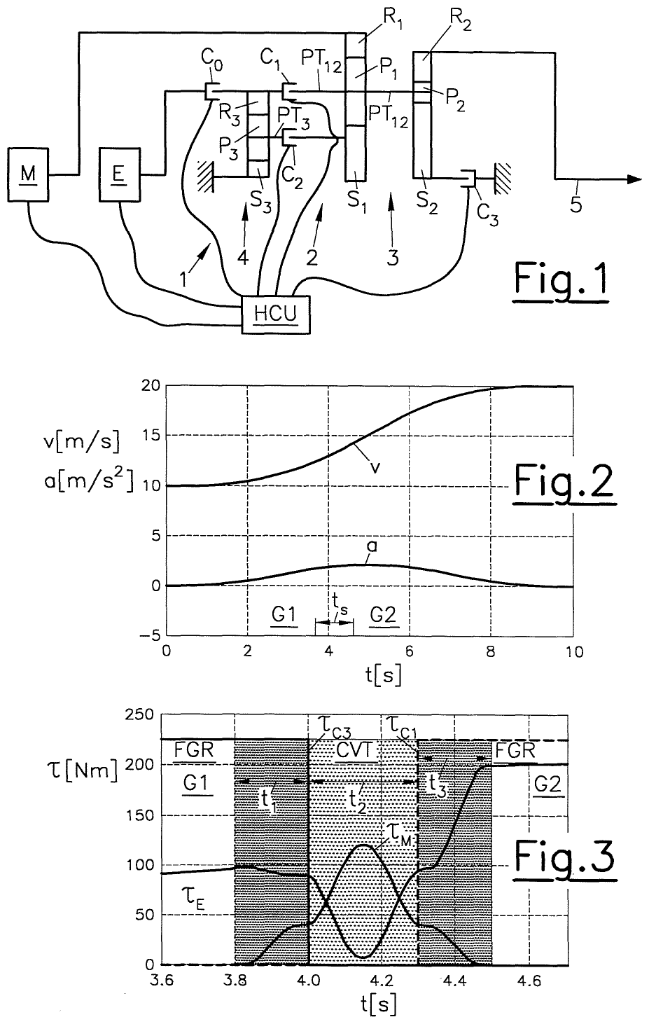

FIG. 1 schematically shows a hybrid powertrain for carrying out the method according to the invention;

FIG. 2 shows a curve of the vehicle speed and the vehicle acceleration during a shifting process;

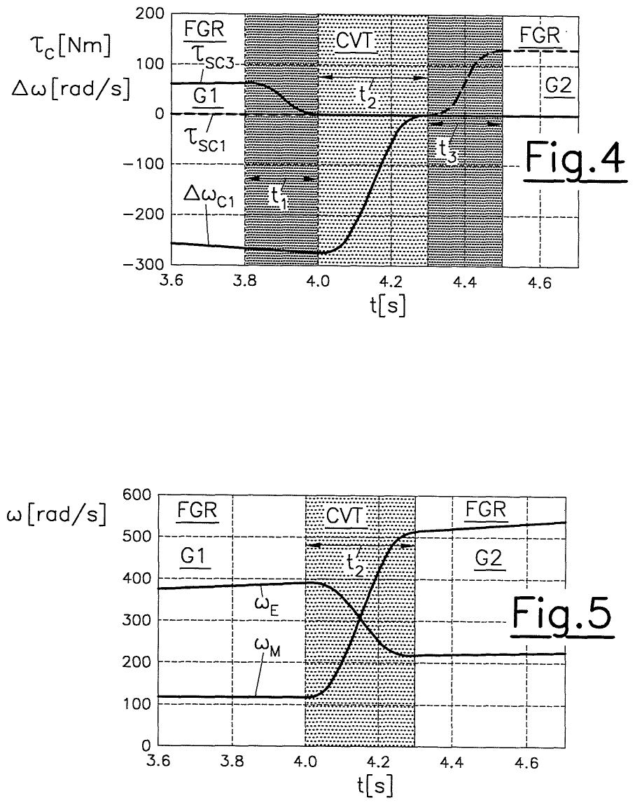

FIG. 3 shows a torque curve during a shifting process;

FIG. 4 shows a clutch torque curve during a shifting process; and

FIG. 5 shows a speed curve of the drive machines during a shifting process.

FIG. 1 shows by way of example a simplified mechanical schematic of a topology of a powertrain 1 having a first drive machine E and a second drive machine M of a vehicle, wherein in the embodiment example the first drive machine E is formed by an internal combustion engine and the second drive machine M is formed by an electric machine. However, the first drive machine E can also be an electric machine. The powertrain 1 has a transmission 2, which connects the drive machines E, M to a transmission output 5 and thus to the drive wheels of a motor vehicle which are not shown further. Transmission 2 in the embodiment example has an extended Ravigneaux planetary gear set 3 and a simple planetary gear set 4. The extended Ravigneaux planetary gear set 3 has a first sun gear S₁, a second sun gear S₂, a common planet carrier PT₁₂ for a set of first planet gears P₁ and a set of second planet gears P₂, a first ring gear R₁ and a second ring gear R₂, wherein the first planet gears P₁ mesh with the second planet gears P₂. The simple planetary gear set 4 has a third sun gear S₃, which engages a third planet gear P₃ of a planet carrier PT₃, and a third ring gear R₃. Furthermore, the transmission 2 has a shiftable first clutch C₀, a shiftable second clutch C₁, a shiftable third clutch C₂ and a shiftable fourth clutch C₃, wherein the shiftable fourth clutch C₃ is designed as a brake. When engaged, the first clutch C₀ establishes a drive connection between the second drive machine E and the third ring gear R₁ When engaged, the second clutch C₁ establishes a drive connection between the third ring gear R₃ and the common planet carrier PT₁₂. When engaged, the third clutch C₂ connects the first sun gear S₁ to the planet carrier PT₃ of the first planetary gear set 4. The fourth clutch C₃ fixes the second sun gear S₂ in engaged condition.

In FIG. 2 to FIG. 5, for example, a shifting process from a first gear G1 with a fixed transmission ratio FGR to a second gear G2 with a fixed transmission ratio FGR and simultaneous vehicle acceleration a (train upshift) using the method according to the invention is shown, in which, for example, the third clutch C₃ is disengaged and the first clutch C₁ is engaged. Power distribution occurs between the first drive machine E and the second drive machine M, wherein the first drive machine E is operated stationary. The second drive machine M supports the shifting process, wherein the values for the power distribution are provided stationary in an FGR transmission mode by the electronic hybrid control unit HCU.

FIG. 2 shows the speed v and the acceleration a of the vehicle over the time t before, during and after a shifting process. As can be seen from FIG. 2, the acceleration a of the vehicle takes place over 10 seconds s, the shifting time tₛ of the shifting process is about 0.7 seconds (from 3.8 to 4.5 s). This shifting time tₛ can only be seen as an example. In the case of faster actuators, the shifting time tₛ can be reduced.

FIG. 3 shows the course of the clutch torque τ_{C3} of the outgoing clutch C₃, the clutch torque τ_{C1} of the oncoming clutch C₁, the drive torque τ_{M} of the first drive machine ICE and the drive torque τ_{E} of the second drive machine EM over time t for a shifting process. Clutch torque is understood here as the maximum torque to be transmitted via the clutch plates of the corresponding clutch. It can clearly be seen that the outgoing clutch C₃ is completely disengaged at time t=4 s and the oncoming clutch C₁ is completely engaged at time t=4.3 s.

FIG. 4 shows the course of the mating torques τ_{SC1}/τ_{SC3} of the outgoing clutch C₃ or the oncoming clutch C₁, as well as the speed difference Δω_{C1} of the clutch plates of the clutch C₁ to be engaged. The term “mating torque” here refers to the torque actually applied to the respective clutch and transmitted via the clutch plates.

FIG. 5 shows the speed curve ω_{E} and ω_{M} of the first drive machine E or the second drive machine M during a shifting process.

The shifting process can be divided into three time ranges t₁, t₂, t₃, which can be modified separately:

Relief phase t₁: Relieving the disengaging (outgoing) clutch C₃ (3.8-4.0 s: duration of t₁; 0.2 seconds)

In the first time range t₁, the aim is to relieve the load on the clutch C₃ to be disengaged in order to avoid grinding immediately after breakaway. For this purpose, either the mating torque τ_{SC3} applied to the outgoing clutch C₃ can be controlled directly to zero, or the power distribution between the first and second drive machine M, E can be modified by the electronic hybrid control unit HCU to implicitly achieve the identical goal. The course of the relevant torque τ_{SC3} is shown in FIG. 4. As soon as the clutch C₃ is completely relieved (time 4.0 s) the clutch C₃ can be disengaged without loss (see τ_{C3} in FIG. 3) and the synchronization phase t₂ can begin.

Synchronization phase t₂: Synchronization of the clutch plates of the engaging (oncoming) clutch C₁ (4.0-4.3 s: Duration of t₂: 0.3 seconds) The aim is to synchronize the clutch plate speeds or eliminate the speed difference Δω_{C1} of the clutch plates of the clutch C₁ to be engaged (see FIG. 4). As soon as there is no speed difference Δω_{C1} between the clutch plates C₁ to be engaged (time 4.3) the respective clutch C₁ can be engaged without loss (see torque τ_{SC1} of the oncoming clutch C₁ in FIG. 4). Once synchronization is complete, the restoration of the power distribution required by the electronic hybrid control unit HCU can begin.

### Recovery Phase t₃: Restoration of Power Distribution (by HCU)

The aim of the third phase t₃ is to restore the power distribution required by the HCU between the first drive machine E and the second drive machine M. This transition is also carried out gently in order to avoid unrealistic loads on the actuators (e.g. torque jumps). This process corresponds to a gentle loading of the newly engaged clutch C₁ (see torque τ_{SC1} of the oncoming clutch C₁ in FIG. 4).

During the illustrated shifting process from the first gear G1 driven in FGR mode, a change into CVT mode takes place in the first time range t₁ and second time range t₂ and then again into FGR mode of the second gear G2.

Compared to the prior art, the method according to the invention has the following advantages:
The shifting strategy is not dependent on the shifting process (e.g. pull-up shifting).
The shifting process can be carried out without loss, as there are no sliding clutches. For real clutch actuation (finite rise times) only the differential speed of the engaging clutch must be kept at zero for the duration of the clutch actuation or an additional phase after phase 1 must be inserted in which the differential speed of the disengaged clutch is kept at zero for the duration of the clutch actuation. The strategy is therefore also robust against inaccuracies in the clutch actuation. This makes it possible to replace friction clutches in a powertrain topology with much cheaper and more robust claw clutches.
The shifting process can be carried out completely without jerking: There is no effect of the shifting process on the desired vehicle acceleration, not even if the clutches are activated stepwise.
It is not necessary to adapt the shifting process for changes in the nominal drive torque (driver) during the shifting process.
The time sequence of the shifting process does not have to be subdivided into torque transfer and speed phase.
The method can be implemented with a simple adjustment effort: For example, a simple pilot control principle can be used, which is based on fulfilling two wishes simultaneously using two actuators.

The basic idea of the pilot control is that actuating signals for the shifting process are calculated in such a way that a certain behavior is achieved for degrees of freedom; trajectories (e.g. the vehicle speed) are specified for this purpose. To solve this problem, the system must be inverted. This generally leads to causality problems. This restriction can be removed by assuming that the derivations of the trajectories are known. The actuating signals are then calculated from a filtered linear combination of these derivations, wherein the filter and the linear combination contain the inverse model behavior. The linear combination results from the counter polynomials of the inverse transmission matrix of the system. The transmission matrix defines the model input/output behavior in the frequency domain, in this case the behavior of the wheel drive torque and slip speed of the oncoming clutch (in the case of CVT transmission mode) or the wheel drive torque and mating torque of the outgoing clutch (in the case of FGR transmission mode). The filters result from the denominator polynomials of this inverse transfer matrix. The number of necessary derivations corresponds to the relative degrees of the individual transmission paths. The relative degrees are given by the order differences (degrees of difference) in the transfer matrix.

The method described is suitable for all powertrain topologies with two drive machines E, M and a transmission 2, which has at least one transmission mode with fixed transmission ratio FGR and at least one transmission mode with variable transmission ratio CVT, with at least two shiftable clutches C₁, C₃. It is not limited to a certain number of gears or transmission type.

1. A method for controlling a shifting process in a powertrain of a vehicle having a first drive machine and a second drive machine, a transmission connecting the drive machines to a transmission output and at least one shiftable clutch, the method including the steps of:
disengaging, during a shifting process, an outgoing clutch and/or engaging an oncoming clutch,
operating the transmission in a fixed transmission ratio in a first transmission mode and in a variable transmission ratio in a second transmission mode,
during a relief phase, the outgoing clutch is relieved before disengagement, and/or in a synchronization phase a differential speed between a drive side and a driven side of the oncoming clutch is adjusted to zero before engagement, and
simultaneously with the relief phase and/or the synchronization phase, a wheel drive torque continues to be adjusted to a target drive torque.

2. The method according to claim 1, characterized in that the relief of the outgoing clutch is carried out by adjusting a mating torque of the outgoing clutch to zero.

3. The method according to claim 1, characterized in that the relief of the outgoing clutch is carried out by dividing the wheel drive torque between the first and second drive machine in such a way that a mating torque of the outgoing clutch is zero.

4. The method according to claim 3, characterized in that a torque distribution between the first and second drive machine is carried out by means of model-based pilot control.

5. The method according to claim 1, characterized in that the adjustment of the differential speed between the drive side and the driven side of the oncoming clutch is carried out before engagement to zero by means of model-based pilot control.

6. The method according to claim 1,
characterized in that the regulation of a mating torque of the outgoing clutch and the regulation of the differential speed between the drive side and the driven side of the oncoming clutch during the relief phase or the synchronization phase of the shifting process are carried out immediately one after the other.

7. The method according to claim 1, characterized in that during the relief phase of the outgoing clutch the transmission is operated with a fixed transmission ratio.

8. The method according to claim 1, characterized in that during the synchronization phase of the oncoming clutch the transmission is operated with variable transmission ratio.

9. The method according to claim 1, characterized in that before the relief phase of the outgoing clutch and/or after the synchronization phase of the oncoming clutch the transmission is operated with a fixed transmission ratio.

10. The method of claim 2, characterized in that the relief of the outgoing clutch is carried out by dividing the wheel drive torque between the first and second drive machine in such a way that the mating torque of the outgoing clutch is zero.

11. The method of claim 4, characterized in that the adjustment of the differential speed between the drive side and the driven side of the oncoming clutch is carried out before engagement to zero by means of model-based pilot control.

12. The method of claim 5, characterized in that the regulation of a mating torque of the outgoing clutch and the regulation of the differential speed between the drive side and the driven side of the oncoming clutch during the relief phase or the synchronization phase of the shifting process are carried out immediately one after the other.

13. The method of claim 6, characterized in that during the relief phase of the outgoing clutch the transmission is operated with a fixed transmission ratio.

14. The method of claim 7, characterized in that during the synchronization phase of the oncoming clutch the transmission is operated with variable transmission ratio.

15. The method of claim 8, characterized in that before the relief phase of the outgoing clutch, and/or after the synchronization phase of the oncoming clutch, the transmission is operated with a fixed transmission ratio.

16. The method of claim 4, wherein a torque distribution between the first and second drive machine is carried out by means of at least one trajectory.

17. The method of claim 5, wherein the adjustment of the differential speed between the drive side and the driven side of the oncoming clutch is carried out before engagement to zero by means of at least one trajectory.

18. The method of claim 1, wherein during a relief phase the outgoing clutch is completely relieved before disengagement.

19. The method of claim 1, wherein the at least one shiftable clutch is two shiftable clutches.
